(19) United States
(12) Patent Application Publication
(10) Pub. No.: US 2012/0271970 A1
(43) Pub. Date: Oct. 25, 2012

(54) SITUATIONAL PLAYBACK

(75) Inventor: James E. Mason, Campbell, CA (US)

(73) Assignee: APPLE INC., Cupertino, CA (US)

(21) Appl. No.: 13/091,008

(22) Filed: Apr. 20, 2011

(51) Int. Cl. G06F 13/10

(52) U.S. Cl. 710/15

(57) ABSTRACT

Broadly speaking, the embodiments disclosed herein describe an apparatus, system, and method for processing a media asset by a media asset player in accordance with situational information related to a previous relationship between an identified external device and the media asset player. In one of the described embodiments, the identified external device is physically connected to the media asset player. In another embodiment, the identified external device is wirelessly connected to the portable communication device. In any case, the relational processing of the media asset takes place only while the media asset player is in communication with the external device.

### FIELD OF THE DESCRIBED EMBODIMENTS

The described embodiments relate to a portable media device and more particularly to processing media assets in accordance with a situational context of the portable media device.

### DESCRIPTION OF THE RELATED ART

Portable media devices have become ubiquitous in that they can provide an end user with a great amount of multimedia information wherever and whenever desired. One of the great advantages to the end user of the portable media device is that the end user can easily carry the portable media device about for use in any number of different venues at any time.

However, one of the problems associated with such mobility and large number of available media assets is the difficulty in maintaining a clear and concise record of media assets that are processed at particular times and locations. For example, the end user may enjoy listening to a particular genre of music, or a particular episodic media item (audio book, podcast, etc.) at particular times and/or locations. Keeping track of the various possible combinations of media assets played, time of play, manner of playing, etc. can be overwhelming.

Therefore, what is desired is a simple yet effective approach to manage the playing of media assets by a highly portable media play device.

### SUMMARY

Broadly speaking, the embodiments disclosed herein describe maintaining a record of a relationship between a media asset player and an external device. In one embodiment, the external device and the media asset player can be in wireless communication with each other. In another embodiment, the external device can take the form of a docking station that can be physically connected to the media asset player using a connector. In any case, the media asset player can use information from the external device to identify media assets and a manner of processing the media assets in accordance with a previous relationship between the external device and the media asset player.

A method performed by a media asset player is described. In the described embodiment, the media asset player includes a memory device arranged to store at least a media asset and a processor arranged to process the media asset. The method can be performed by establishing communication between the media asset player and an external device, identifying the external device, and processing the media asset in a manner associated with a previous relationship between the media asset player and the identified external device only while the communication between the media asset player and the external device remains established.

In one aspect of the described embodiment, the media asset player and the external device are in wireless communication with each other. In another aspect of the described embodiment, the external device takes the form of a docking station arranged to be physically connected to the media asset player by way of a physical connector.

In another embodiment, a media playback system is described. The media playback system includes at least a first electronic circuit. The first electronic circuit includes a processor, a data store arranged to retain at least a media asset, and a first connector assembly. The media playback system also includes a second electronic circuit that includes at least a second data store arranged to retain at least second electronic circuit identification information, and a second connector assembly. When the first and second connector assemblies are electrically coupled to each other, the first electronic circuit receives at least some of the second electronic circuit identification information and if it is determined by the first electronic circuit that the first electronic circuit and the second electronic circuit have been previously connected to each other, then the first electronic circuit processes the media asset in accordance with information related to the previous connection.

In yet another embodiment, non-transitory computer readable medium for storing a program executable by a processor in a media asset player is described. The non-transitory computer readable medium includes at least computer code for establishing communication between the media asset player and a docking station, the media asset player including a memory device arranged to store at least a media asset and a processor arranged to process the media asset, computer code for identifying the docking station by the processor, and computer code for processing the media asset in a manner associated with the identified docking station only while the communication between the media asset player and the docking station remains established.

In still another embodiment, a media asset player includes at least a data store arranged to retain at least a media asset, a connector assembly arranged to facilitate the establishment of a communication channel between the media asset player and another electronic circuit and a processor. The processor identifies the other electronic circuit, retrieves the media asset from the data store, and processes the media asset in a manner associated with the identified other electronic circuit only while the communication channel between the media asset player and the other electronic circuit remains established.

In yet another embodiment, a method performed by a media asset player that includes a memory device arranged to retain at least a media asset and a processor arranged to process the media asset is described. The method can be carried out by the processor relationally processing a media asset by the media asset player. In the described embodiment, the relational processing of the media asset is in accordance with a previous relationship between the media asset player and another electronic device.

In one aspect of the described embodiment, the other electronic device is coupled to a docking station where the information about the docking station is used to determine if there was a previous relationship between the media asset player and the other electronic circuit.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 is a block diagram of a media player/docking station system in accordance the described embodiments.

FIG. 2 shows a representative media playback memento file in accordance with the described embodiments.

FIG. 3 shows a flowchart detailing process in accordance with the described embodiments.

FIG. 4 shows a flowchart detailing process for memorializing a communication session between a media asset player (MAP) and a docking station in accordance with the described embodiments.

FIG. 5 shows a flowchart detailing process that can be performed by a system that includes a media asset player (MAP) and a docking station while in communication with each other.

FIG. 6 shows a flowchart detailing process for creating a new media playback memento file or updating an existing media playback memento file at a MAP while the MAP and docking station are in communication with each other.

FIG. 7 is a diagram of a media system according to one embodiment of the invention.

FIG. 8 is a block diagram of an arrangement of functional modules utilized by a portable media device.

FIG. 9 is a block diagram of media player in accordance with the described embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

The media asset player described herein can be equipped to carry out various multimedia and other types of personal communication functions. In one embodiment, the media asset player can take the form of a dedicated portable media player such as an iPod™ manufactured by Apple Inc. of Cupertino, Calif. arranged to process media assets such as video data and audio data such as MP3 files. The media asset player can also take the form of a multi-function device along the lines of a smartphone such as an iPhone™ also manufactured by Apple Inc. of Cupertino, Calif. In any case, the embodiments described herein relate to processing the media assets by the media asset player in accordance situational data corresponding to a pre-existing relationship between the media asset player and a docking station in communication therewith. It should also be noted that the concept of a docking station can be extended to include any external circuit that can communicate with the media asset player. Such external circuits can include headphones, speakers, stereo boom boxes, and so on. For example, the reference to a docking station does not necessarily imply a stand-alone system. The docking station can in fact be an integrated part of an electronic device or system and should not be construed only as a simple stand-alone unit devoid of any relationship to a larger or more complex entity.

In one aspect of the described embodiment, the pre-existing relationship between the media asset player and the docking station can be defined in terms of physical environment factors and context of use factors that can be embodied as situational data. For example, physical environment factors such as time of day, ambient light, and so on can be used singly or in combination to define a local physical environment. The factors to be considered that can help define the physical environment can include, for example, time of day, physical location, location in either a wired or wireless network, physical orientation, velocity, ambient light, and so on. The physical environment can also include such factors as those related to a configuration state in which the media asset player operates for a period of time. For example, when the media asset player has wireless capabilities (such as BlueTooth™, WiFi™, and so on), the media asset player can be associated with a particular address that can be used to identify media asset player in the network. If the status of the media asset player changes within the network (by, for example, turning the media asset player off or moving outside the range of the network), then the change of status (or any other appropriate network characteristic such as network address) can be treated in much the same way as a docking event or a de-docking event that can be used to define the situational data of the personal communication device.

For example, when the media asset player is wireless capable and is in wireless communication with an external device using for example AirPlay™, each device has an identifiable AirPlay™ device name used by the media asset player to establish an audio only or audio/video routing between the media asset player and the external device. Once the routing between the media asset player and the external device is established, the situational data associated with that particular configuration can be identified and stored as needed. However, an externally initiated audio or audio/video change occurs (such as moving out of range, turning one device or the other off or in another operating mode inconsistent with AirPlay™) can be considered equivalent to a de-docking event that can be used to identify situational data that can be used to re-establish a current operating condition for the media asset player at a subsequent docking event such as when the media asset player and the external device re-establish a wireless AirPlay™ connection.

Other factors can be considered to help define the context of use (also referred to as the contextual environment) of the media asset player can include such factors as a manner in which the media asset player is currently or has recently been used and a manner in which the media assets are processed. For example, a playback state can be identified that can include a history of playlists played, podcast episodes played and duration of same, bookmarked portions of audio books, a scene in video, and so on. In this way, operation of the media asset player can be tailored to a specific docking station and as such can be used to recreate an end user's experience provided by the media asset player the last time that the media asset player and the docking station were in communication with each other.

For example, when the media asset player and the docking station are in communication with each other, the media asset player can record both the physical and the contextual environment of the media asset player in real time and store the information to a media playback memento file. When the communication between the media asset player and the docking station is ended (or simply paused when the media asset player powers down), the media playback memento file can be locked such that no further updates can take place if and until the communication between the media asset player and the docking station is re-established. When the communication is re-established, identification of the docking station can be used to direct the operation of the media asset player and more particularly to a specific manner of processing the media assets using information stored in the media playback memento file.

In one embodiment, the media asset player can be configured to include a connection mechanism that can be used to provide a communication channel between the media asset player and an external circuit. The external circuit can include processing, power utilization, and memory resources that can be used by the media asset player. The external circuit can be disposed within the housing. The housing can include a receiving portion arranged to mechanically couple with and support the media asset player. In this case, the combination of the housing and the external circuit can take the form of the docking station, or more simply, a dock. In another embodiment, the communication channel between the external circuit and the media asset player can be facilitated by a mechanical connector (such as FireWire™ type connector, a 30 pin type connector, and so forth). In another embodiment the communication channel can be wireless in nature in which case no mechanical connection between the external circuit and the media asset player is necessary.

The docking station can include identification data that can uniquely identify the docking station (to be more specific, the external circuit disposed within the housing of the docking station is uniquely identified). The docking station identification data (also referred to as a dock ID) can be used by the media asset player to uniquely identify a particular docking station. In this way, data stored within the media asset player can be uniquely associated with a particular docking station using the dock ID. The media asset player can store the data in a media playback memento file. The media playback memento file can be stored as part of a look up table (LUT) having a plurality of dock IDs each pointing to a corresponding media playback memento file. The media playback memento file can be updated in real time while the media asset player and the docking station remain in communication with each other and locked whenever the communication channel between the media asset player and the docking station is terminated.

The termination of the communication between the media asset player and the docking station can be associated with, for example, a physical disconnection of the media asset player and the docking station (referred to as a de-docking event). The termination of the communication can also be associated with the media asset player being powered off as the result of, for example, an end user manually turning off the media asset player or the media asset player entering a sleep mode. In any case, the termination of the communication can be considered to be a terminating event that can trigger the media asset player to complete updating the media playback memento file. The updating of the media playback memento file can include updating information such as an identification of a currently played media asset (along with the associated metadata), a time of day of the terminating event, operating status of the media asset player at the time of the terminating event, and so on. In one embodiment, the updating of the media playback memento file can be done on a continuous, semi-continuous, or as needed basis depending upon just how detailed and how much information is deemed necessary to recreate the end users experience of the processing of the media assets by the media asset player.

In this way, at a subsequent re-establishing of the communication between the media asset player and the docking station (i.e., a docking event), the situational data in the form of the physical factors and context of use factors stored in the media playback memento file associated with the particular dock ID can be identified and if necessary, retrieved and used by the media asset player. In one mode, the retrieved situational data can be used by the media asset player to re-start the media asset processing by the media asset player at about the same point corresponding to the terminating event. For example, a podcast can be restarted at the same point where it was stopped in response to the terminating event. In some cases, the end user can arrange it such that the media asset processing by the media asset player can restart at a next one in a series of episodic media assets. For example, when the media asset player is docked to the docking station, the media asset player can broadcast a next one in the series of podcasts, a next chapter in an audio book (or e-book when the media asset player can act as an e-book) and so on. Therefore, the media asset player will have to determine if the next one of the series is present and if not access and download the next in the series prior to presentation to the end user.

In another mode, the situational data can be used by the media asset player to resume operation in an operating state consistent with the operating state coincident with the terminating event. In this case, the media asset player can use an operating history of the media asset player to continue operation in a manner consistent with that of the termination event. For example, in those situations where the media asset player can communicate with a media asset repository, such as that associated with iTunes™, the situational data can include a seed track used by iTunes™ (more specifically Genius™ algorithm) to create a playlist that can then be played by the media asset player. In some cases, however, a previously provided playlist can be stored in its entirety and associated with the dock ID that can then be identified and processed by the media asset player. This arrangement is of particular interest as there is no guarantee that the Genius™ algorithm will return exactly the same playlist even when provided the same seed track. Therefore, a favored playlist can be stored and then identified with the particular dock using the dock ID.

In another embodiment, the situational data can include identification of external devices that can be used by the media asset player to present either or both audio content and video content to an end user. For example, the external device can take the form of a speaker that can be uniquely identified by a speaker ID. When the media asset player is connected to the docking station and the situational data includes the speaker ID, then part of the processing of the media assets by the media asset player can include a specific media asset or type of media asset associated with the particular speaker. For example, when the end user comes home and docks the media asset player to the docking station, if a speaker ID present in the situational data matches a local speaker, then a communication link using, for example, AirPlay™ can be used to transport processed media asset data in the form of audio to the selected speaker. In this way, the end user can rely upon a particular music genre being played upon returning home. It should be noted that the act of docking the media asset player can be accomplished using a mechanical connector as well as wirelessly by the end user merely bringing the media asset player within a specified range of a wireless node within the residence.

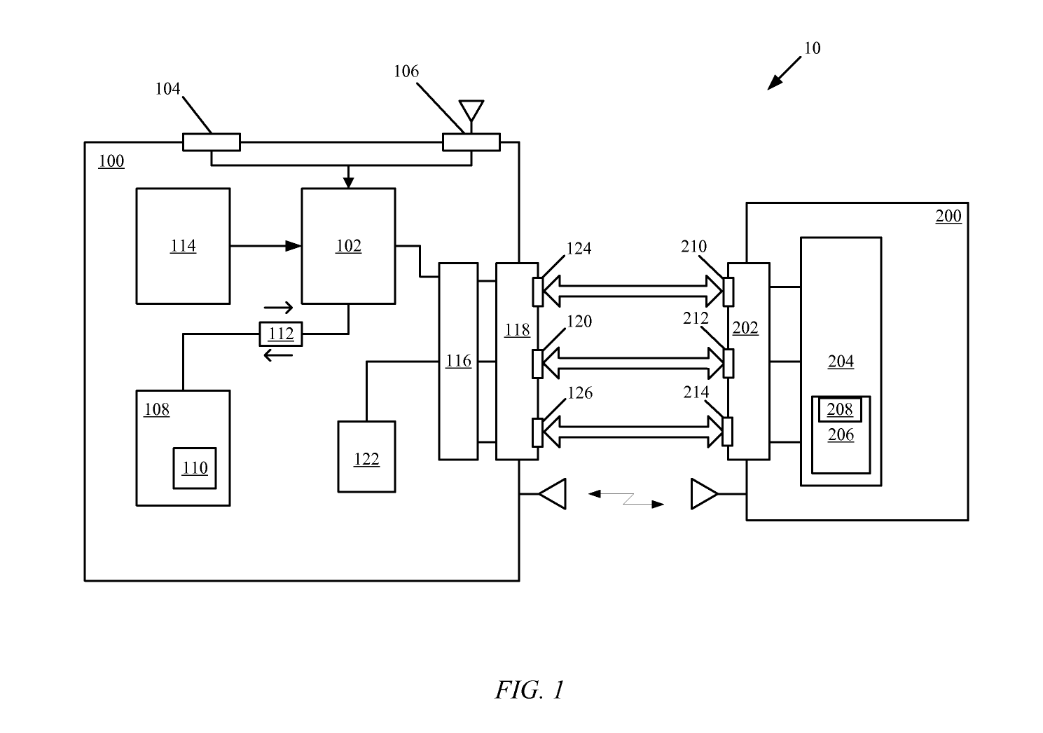

These and other embodiments are discussed below with reference to FIGS. 1-9. However, those skilled in the art will readily appreciate that the detailed description given herein with respect to these figures is for explanatory purposes as the invention extends beyond these limited embodiments.

FIG. 1 is a block diagram of a media asset player/external device system 10 in accordance the described embodiments. System 10 generally includes media asset player 100 and external device 200. External device 200 can take many forms. For example, external device 200 can be wireless capable such that media asset player 100 can be in wireless communication with external device 200 using an appropriate wireless protocol such as BlueTooth™, WiFi™. In other embodiments, external device 200 can take the form of a docking station into which media asset player 200 can be placed or otherwise connected to. For the remainder of this discussion, external device 200 will be considered to take the form of docking station 200 without any loss of generality.

Media asset player 100 can include processor 102 (e.g., CPU or microprocessor) configured to execute instructions and to carry out operations associated with media asset player 100. For example, using instructions retrieved for example from memory, processor 102 can control the reception and manipulation of input and output data between components of media asset player 100. In most cases, processor 102 can execute instructions under the control of an operating system or other software. Processor 102 can be a single-chip processor or can be implemented with multiple components. Media asset player 100 can include a number of sensors that can be used detect certain aspects of the environment in which media asset player 100 is located. The sensors can include, for example, ambient light sensor (ALS) 104 that can be used to detect an amount of ambient light in the local environment. The amount of ambient light can be an indication of a current location of media asset player 100 (e.g., inside vs. outside). The sensors can also include location sensor 106 arranged to provide data that can be used by media asset player 100 to deduce a current geographical or physical location of media asset player 100. Location sensor 106 can utilize various location technologies such as GPS, cellular telephone base station locators, and so on. Various other sensors (not shown) can include temperature sensors used to detect both internal and external temperatures, an accelerometer and gyroscope to detect motion and 3D spatial orientation, a magnetometer along the lines of a compass to detect external magnetic fields including field strength and direction, and so on. Accordingly, the sensors can provide a wealth of information that can be used by media asset player 100 to deduce and characterize a local physical environment in which media asset player 100 is currently located.

Processor 102 together with an operating system can operate to execute computer code and produce and use data. The computer code and data can reside within data storage block 108 that is operatively coupled to the processor 102. Data storage block 108 generally provides a place to store or retain data that is being used by media asset player 100 as well as in some embodiments system 10 as a whole. By way of example, data storage block 108 may include Read-Only Memory (ROM), Random-Access Memory (RAM), hard disk drive, flash memory and/or the like. As is generally well known, RAM is used by processor 102 as a general storage area and as scratch-pad memory, and can also be used to store input data and processed data. ROM can be used to store instructions or program code followed by the processor as well as other data. Hard disk drives can be used to store various types of data and can permit fast access to large amounts of stored data. The computer code and data could also reside on a removable program medium and loaded or installed onto the computer system when needed. In one embodiment, data storage block 108 can be configured to store media playback memento file 110 that can be used by processor 102 for controlling the processing of media assets by media asset player 100 in accordance with situational data 112 derived in part from data provided by the sensors (such as ALS 104) and user input at user interface 114 operatively coupled to processor 102. For example, the media assets can include playlist(s) that can also be stored in storage block 108. In one embodiment, the playlist can be accessed through user interface 114. User interface 114 (also referred to as graphical user interface, or GUI) can include a display for visually displaying the song lists (as part of the GUI interface) and a touch pad or buttons for selecting a song to be played or reviewing and/or customizing the song lists, i.e., the user may quickly and conveniently review the lists and make changes or selections thereto. User input events at GUI 114 can be used to help define situational data 112.

Media asset player 100 can also include input/output (I/O) controller 116 that can be operatively coupled to processor 102. I/O controller 116 can be integrated with processor 102 or it may be a separate component as shown. I/O controller 116 can be generally configured to control interactions with docking station 200 that can be coupled to media asset player 100. I/O controller 116 generally operates by exchanging data (and/or power) between media asset player 100 and docking station 200. In some cases, docking station 200 can be connected to I/O controller 116 through wired connections whereas in other cases docking station 200 can be connected to I/O controller 116 through wireless connections.

Media asset player 100 can also include connector 118 capable of connecting to corresponding connector 202 located at docking station 200. Docking station 200 can be operatively coupled to media device 100 through circuitry 204. For example, circuitry 204 can be hard wired to media device 100 as for example when docking station 100 is integrated with media device 100 or it can be passively wired as through a cord (such as a FireWire or USB connection) that temporarily plugs into media device 100, or directly wired by way of connector arrangement 118/202. Circuitry 204 can include data storage resources 206. Data storage resources 206 can take the form of a memory device such as FLASH memory in which can be stored information related to docking station 200. The information can include information that can be used to uniquely identify docking station 200. In one embodiment, the identifying information can take the form of dock ID 208. Dock ID 208 can be used to uniquely identify docking station 200 and as such can be used to associate situational data 112 and docking station 200.

Connector arrangement 118/202 used to connect media asset player 100 and docking station 200 can be widely varied. However, in the illustrated embodiment, connector arrangement 118/202 includes both power and data contacts. Power contacts 120 of media asset player 100 are operatively coupled to battery 122 of media asset player 100 and data contacts 124 of media asset player 100 are operatively coupled to I/O controller 116. As should be appreciated, the power contacts 120 of connector 118 are configured to engage power contacts 212 of connector 202 so as to provide operational or charging power to media asset player 100, and data contacts 124 of connector 118 are configured to engage data contacts 210 of connector 202 so as to provide data transmissions to and from media asset player 100 and docking station 200. The data contacts may be widely varied. For example, they may be configured to provide one or more data transmitting functionalities including Firewire™, USB, Ethernet, and the like. The connectors may also include a variety of other contacts 126/214 for transmitting other types of data as for example remote control, video (in/out), audio (in/out), digital TV, and the like. It should also be noted that in the case where external device 200 and media asset player 100 can communicate with each other wirelessly, then media asset player 100 can also include wireless components such as a wireless transceiver unit and associated antenna (neither of which are shown).

A contextual environment of media asset player 100 can be deduced by processor 102 based upon many factors. In general, the factors to be considered to help define the contextual environment of media asset player 100 can include a manner in which media asset player 100 is currently or has recently been used and a manner in which the media assets have, are, or will be processed. For example, an end user can use GUI 114 to select a playlist(s) as well as operational settings of media asset player 100 such as volume, equalizer settings (treble, bass, etc.) to be applied by processor 102 in the processing of media assets by media asset player 100. In this way, processor 102 can provide a controller history of media asset player 100. The controller history of media asset player 100 can include, in addition to the operational settings of media asset player 100, information related to a playback state that can be defined as a history of media asset processing carried out by media asset player 100. The playback state can include information such as playlists actually played, a podcast episode played and duration of play, chapter in an audio book and any bookmarked portion thereof, a scene in video, and so on. The playback state information can be used to recreate a previous operating condition of media asset player 100 based solely upon a particular value of dock ID 208 and extrinsic factors such as time of day or ambient light level and so on.

For example, processor 102 can record metadata of media assets selected by an end user by way of user inputs at GUI 114. The recording of the metadata can indicate those media assets that have been played, are currently being played, or are scheduled to be played. For example, the end user can select a playlist by imparting a touch event at GUI 114. The playlist can include a list of media assets, such as songs, that can be played in a particular order, or random order, or any order the end user deems appropriate. Information related to the selection and processing of the playlist can be stored in media playback memento file 110. In another example, the end user can also use GUI 114 to select a podcast to play. Processor 102 can record appropriate metadata associated with the selected podcast that can also be used to update media playback memento file 110. Processor 102 can use this and other information to deduce the contextual environment of media asset player 100. For example, information related to a time of day played, an average volume level during play and so on can also be used to help define the contextual environment of media asset player 100 as it relates to media assets being played by media asset player 100.

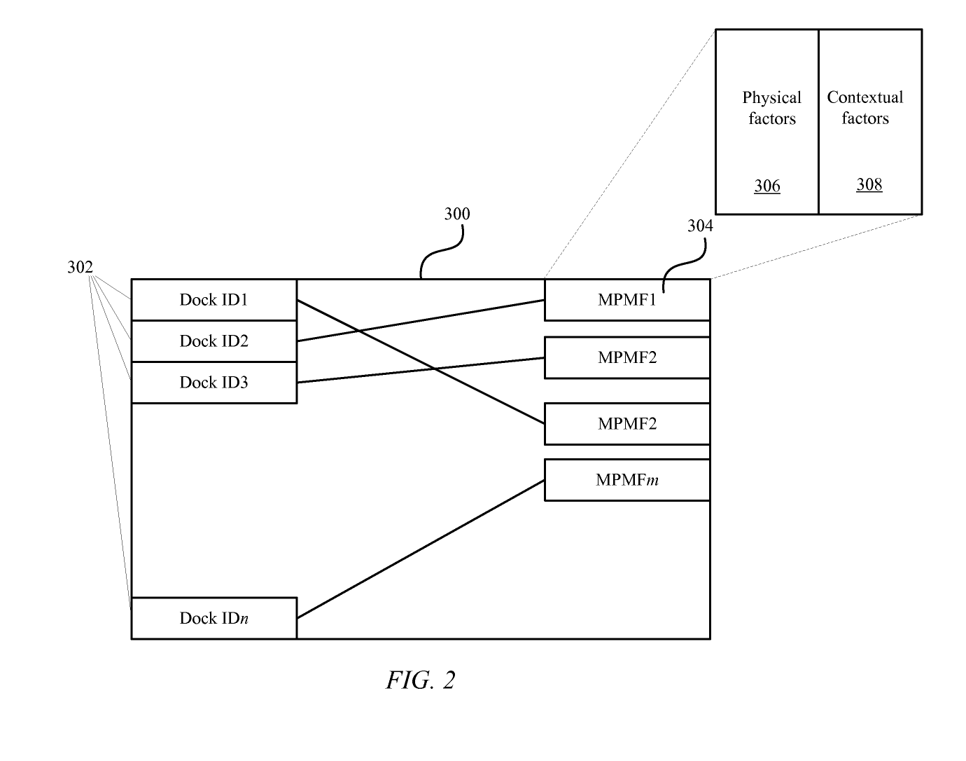

In one embodiment, media playback memento file 110 can be included as part of look up table (LUT) 300 shown in FIG. 2 having a plurality of dock ID(s) 302 each pointing to corresponding media playback memento file (MPMF) 304. Furthermore, each MPMF can be organized to include situational data that can include information related to physical conditions and information related to a context of use of media asset player 100. For example, MPMF 304 can be organized in such a way to include physical data 306 and context of use, or contextual, data 308. MPMF 304 can be updated in real time as long as a communication channel between media asset player 100 and docking station 200 remains open. However, once the communication channel between media asset player 100 and docking station 200 closes, or a communication exchange is paused, processor 102 can lock or otherwise prevent further updating of MPMF 304. In one embodiment, processor 102 can tag MPMF 304 with a time stamp marking a time that the communication between media asset player 100 and docking station 200 ended.

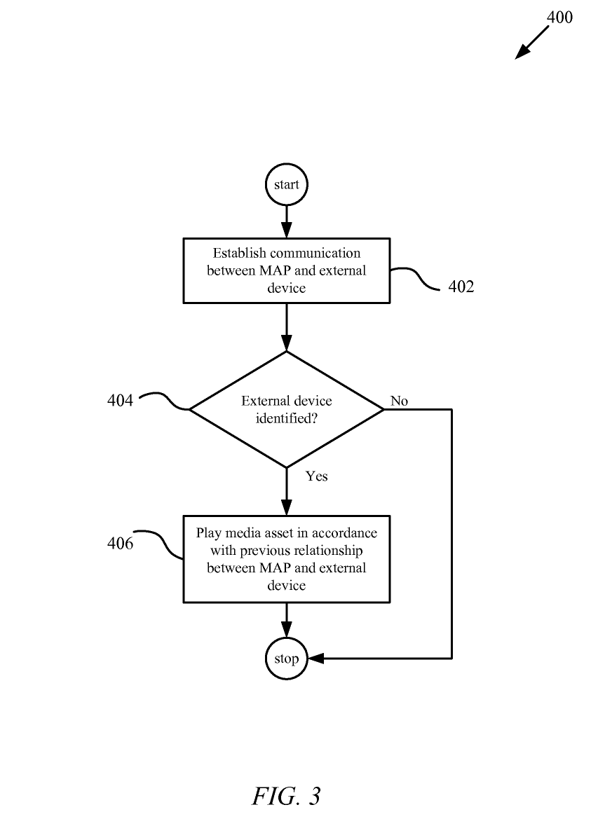

FIG. 3 shows a flowchart detailing process 400 in accordance with the described embodiments. In particular, process 400 can be performed whenever a media asset player (MAP) is docked with or otherwise in communication with a cooperating docking station or other electronic device. By cooperating docking station it is meant to include those docking stations that can identify themselves using information along the lines of a dock ID. In any case, process 400 can begin at 402 by establishing communication between the MAP and the docking station. The communication can take many forms. In one embodiment, the communication can be based upon a wired communication channel established by mechanically connecting the MAP and the docking station. The mechanical connection can be carried out using a pin connector/cable arrangement (such as a 30 pin connector), a cable (such as a FireWire cable) and so on. In another embodiment, the communication can be wireless. The wireless communication can be based upon any appropriate wireless technology such as BlueTooth, WiFi, GSM, CDMA, and so forth.

Once the communication between the MAP and docking station is established, a determination at 404 determines if the docking station is identified by the MAP. An affirmative identification can indicate that the docking station and the MAP have had a previous communication with each other. In one embodiment, the identification can be carried out by the MAP retrieving a dock ID from the docking station and comparing the retrieved dock ID with a dock ID(s) stored in the MAP. The dock IDs stored in the MAP can correspond with those docking stations that have at one point in time communicated with the MAP. If it is determined that the dock ID is not identified, then process 400 ends. Otherwise, at 406 the MAP processes a media asset associated with the identified docking station. It should be noted that the processing of the media asset by the MAP is carried out in a manner in accordance with information associated with the docking station identified by the dock ID.

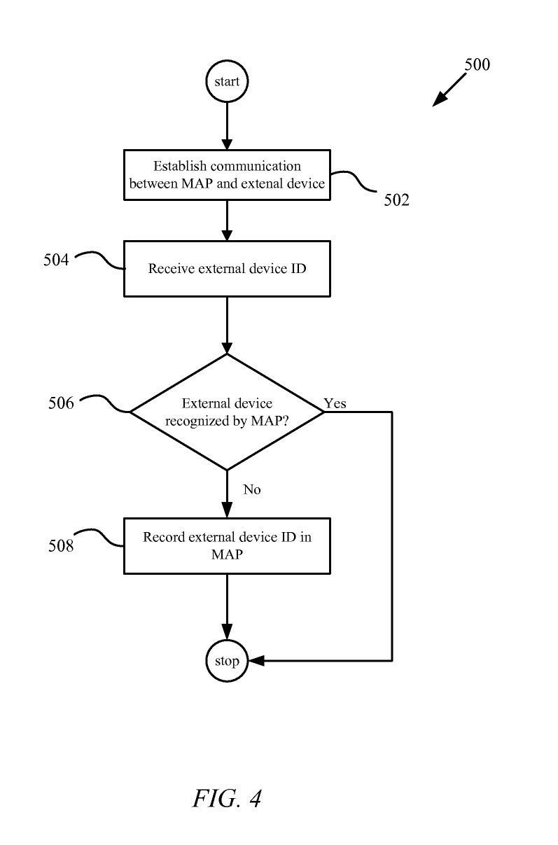

FIG. 4 shows a flowchart detailing process 500 for memorializing a communication session between a media asset player in the form of a media asset player (or MAP) and a docking station in accordance with the described embodiments. Process 500 can begin at 502 by establishing communication between the MAP and the docking station. As above, the communication can take many forms which for sake of brevity will not be repeated. In any case, once the communication between the MAP and the docking station is established, information from the docking station can be received at the MAP. The information can include a dock ID uniquely associated with the docking station. If at 506 the dock ID is not recognized by the MAP, then the dock ID and any other appropriate information is recorded at the MAP at 508. If, however, the MAP recognizes the dock ID associated with the docking station, then there is no need to record the dock ID (as it has already been recorded), and process 500 ends.

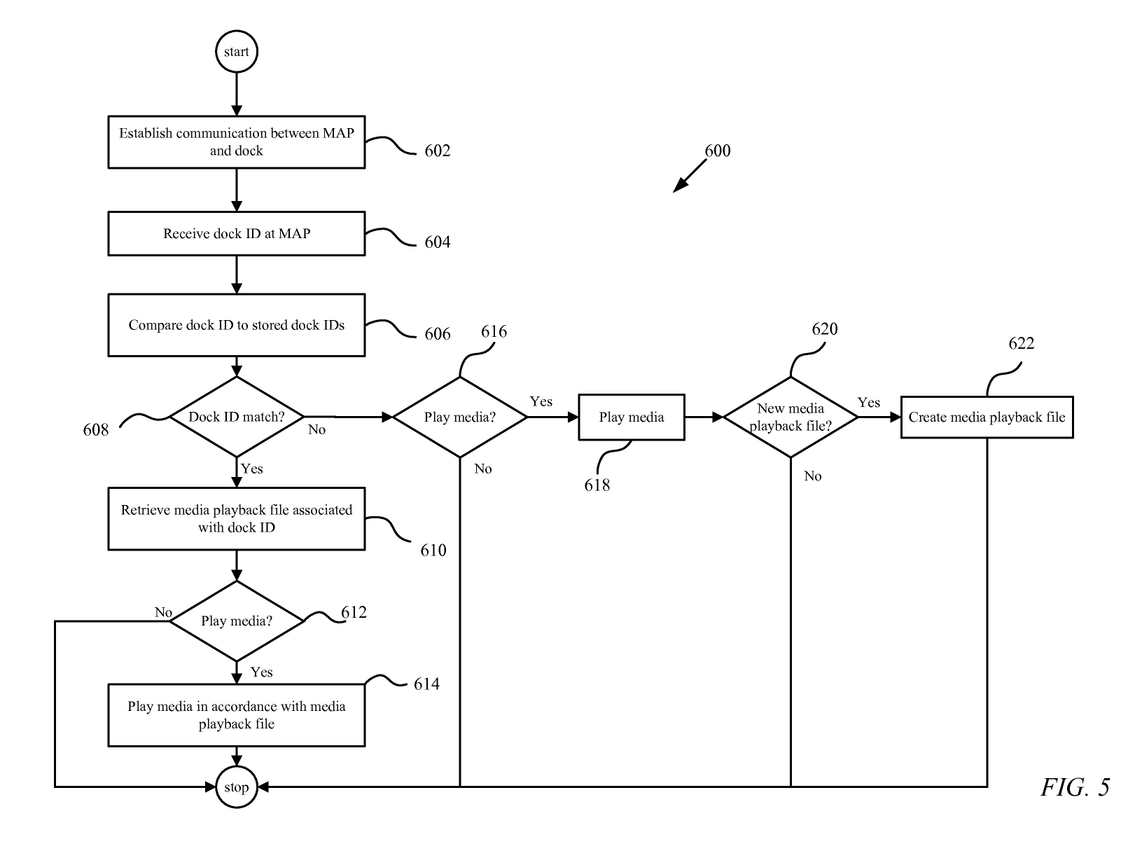

FIG. 5 shows a flowchart detailing process 600 that can be performed by a system that includes a media asset player (MAP) and a docking station. Process 600 can be performed only while the MAP and docking station are in communication with each other. More specifically, process 600 can begin at 602 by establishing communication between the MAP and the docking station. The communication can be wireless communication along the lines of BlueTooth, WiFi and so forth. The communication can be wired communication using any appropriate wired connection media such as FireWire, USB, and so on. In any case, once the communication between the MAP and the docking station is established, the MAP receives information from the docking station that can be used by the MAP to uniquely identify the docking station. The information can include a unique identifier otherwise referred to as a dock ID. The dock ID can be formed of a data string that describes alphanumeric characters or other symbols that can be used by the MAP to identify the make, manufacturer, and style along with any other appropriate information concerning the docking station. Once the MAP has received the identifying information from the docking station, the MAP can compare the received dock ID to dock ID(s) stored in the MAP at 606 to determine if the MAP has a record of a previous communication with the docking station associated with the received dock ID. If at 608, the comparison indicates that there is a match between a stored dock ID and the received ID then the presumption is that the MAP and the docking station have had a previous communication. Accordingly, at 610, a media playback memento file associated with the dock ID and stored in the MAP is retrieved. The media playback memento file can include situational data that can be used to process a selected media asset by the MAP. If at 612 a media asset is to be processed then at 614 the MAP processes the media asset in accordance with situational data stored in the retrieved media playback memento file, otherwise, process 600 ends.

Returning to 608, if it is determined that there is no matching between the dock ID(s) stored in the MAP and the dock ID received from the docking station, then at 616 a determination is made if a media asset is to be processed by the MAP. In some cases, an end user may be placing the MAP in communication with the docking station for nothing more than recharging of the MAP battery or some other reason that does not require that a media asset be processed. In this case, therefore, process 600 ends. Otherwise, at 618, the media asset is processed by the MAP and at 620 a determination is made if a new media playback memento file is to be created for the unmatched dock ID. If no new media playback memento file is to be created for the unmatched dock ID, then process 600 ends, otherwise at 622 a new media playback memento file is created after which process 600 ends.

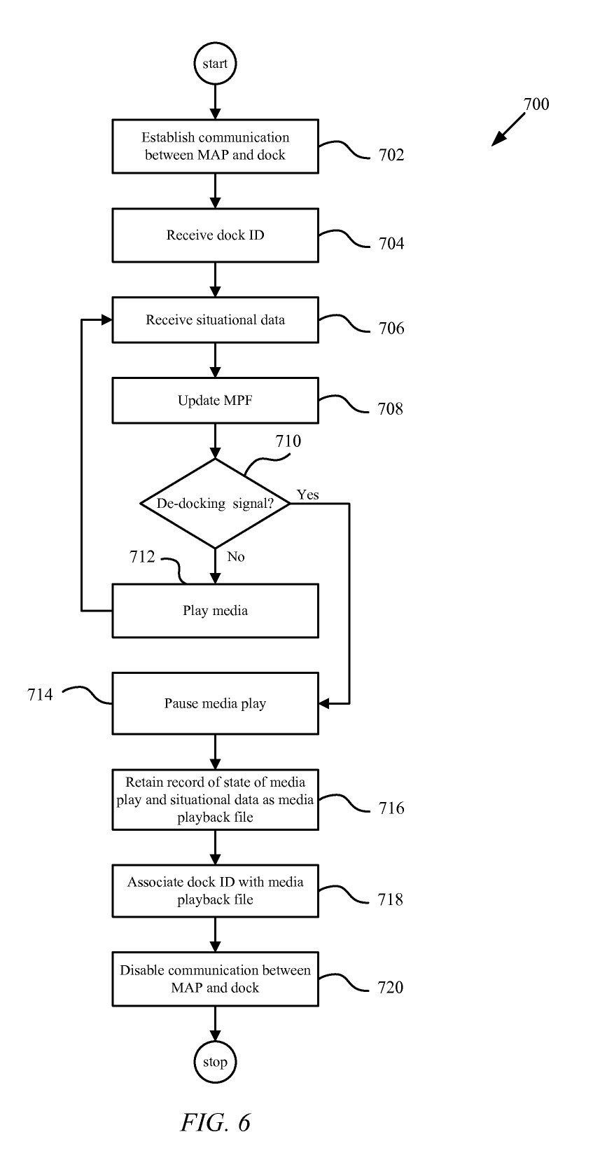

FIG. 6 shows a flowchart detailing process 700 for creating a new media playback memento file or updating an existing media playback memento file (MPMF) at a media asset player (MAP) while a MAP and docking station are in communication with each other. Process 700 can begin at 702 by establishing communication between the MAP and the docking station. The established communication can be based upon a wireless technology such as BlueTooth, WiFi and so on. The established communication can also be based upon a wired connection that relies upon mechanically connecting the MAP and the docking station using an appropriate mechanical connection medium (such as a 30 pin connector and associated cable). Once the MAP and the docking station are in communication with each other, the MAP receives information from the docking station that can be used by the MAP to uniquely identify the docking station. The information can take many forms such as a docking station ID, or more simply a dock ID. Once the MAP obtains the appropriate information from the docking station, the MAP can receive situational data at 706. The situational data can take many forms and have many sources. For example, the situational data can include data from sensors included in or at least in communication with the MAP. Such sensors can provide an indication of a condition of the local physical environment in which the MAP is located. The situational data can also include context of use data based upon a manner in which the MAP processes various media assets. In any case, the situational data can be stored in a media playback memento file (MPMF) at 708 by updating a current MPMF. It is contemplated that as long as the communication between the MAP and the docking station is open, that the MPMF can be updated in real time. In this way, a detailed record of the media processing of the media assets as well as and situational data associated with the MAP can be maintained for possible use at a later time.

At 710, if a de-docking signal is not received, then media asset play continues at 712, otherwise, control is passed to 714 where the media asset play is paused. At 716, the processor acts to prevent the MPMF from being further updated. In one embodiment, the processor can lock or otherwise disable a write operation to the MPMF in order to prevent any further updating except to provide the necessary time stamps or other markers that may be required for subsequent media asset processing. At 718, the MPMF and the dock ID are associated with each other. In this way, a current version of the MPMF can be identified and used by the MAP to process a media asset in accordance with the information stored in the MPMF that is uniquely associated with the docking station. Once updating of the MPMF is complete, de-docking of the MAP and the docking station is completed by breaking down the communication channel between them at 420.

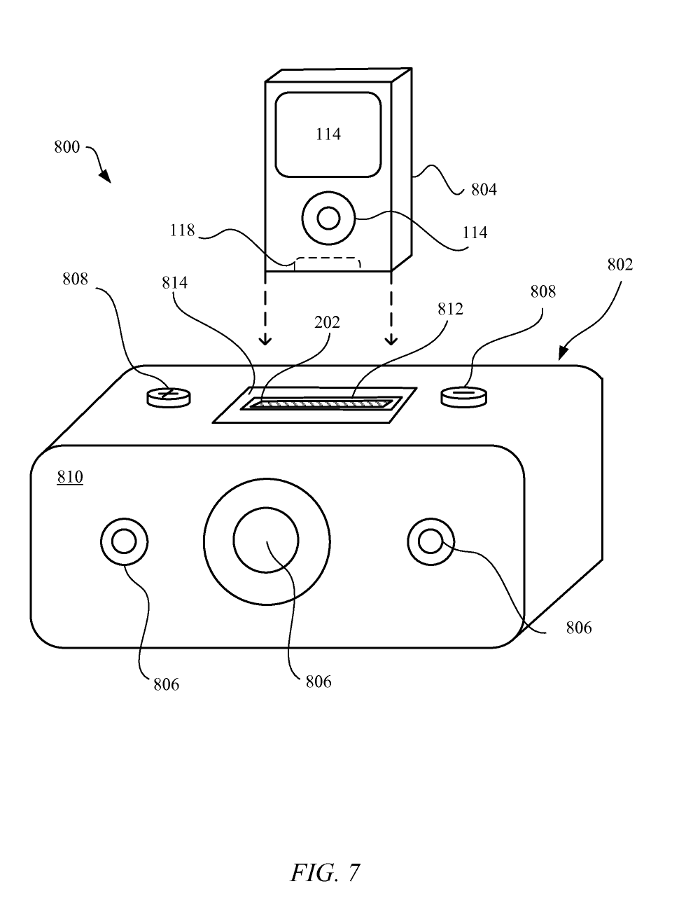

FIG. 7 is a diagram of media system 800 according to one embodiment of the invention. Media system 800 can include first electronic circuit 802 and second electronic circuit 804. In the embodiment shown, first electronic circuit 802 can take the form of media delivery accessory 802 arranged to output the result of processing of a media asset by second electronic circuit 804 in the form of media player 804. For example, media player 804 can process a media asset in the form of a digital audio file to provide an audio signal to media delivery accessory 802. Media delivery accessory 802 can then output the audio signal for presentation to an end user by way of speakers 806 and volume controls 808. Media delivery accessory 802 can include housing 810 that can include an opening or receptacle 812 in which is disposed docking portion 814 that can include at least connector 202 described above. Docking portion 814 of media delivery accessory 802 and in particular connector 202 can electrically connect to connector 118 of portable media player 804. The docking of media delivery accessory 802 and portable media player 804 can be accomplished by placing portable media player 804 in the opening or receptacle 812 such that the connector 118 physically and electrically connects with the connector 202 thereby connecting portable media player 804 and the media delivery accessory 802.

When portable media player 804 is docked to media delivery accessory 802 by way of connection 118/202, portable media player 804 receives information from media delivery accessory 802. Part of the information received from media delivery accessory 802 can include identification information such as a dock ID that uniquely identifies media delivery accessory 802. Portable media player 804 can use the received dock ID to query an onboard database of dock ID(s) corresponding to those docking stations that have previously been connected to portable media player 804. When the query of the onboard database indicates that portable media player 804 and media delivery accessory 802 have previously been connected together, then portable media player 804 can perform additional processing. The additional processing can include querying another database to determine if there is additional information related to the manner portable media player 802 processed a media asset during the previous connection. The additional information can be included in or take the form of a media playback memento file, or MPMF, that can include situational data associated with media delivery accessory. The situational data can include both physical information and contextual, or context of use, information related to the previous interaction between portable media player 804 and media delivery accessory 802.

The MPMF can be used by portable media player 804 to process media assets in accordance with the previous interaction of portable media player 804 and media delivery accessory 802. For example, if a most recent end user experience of media system 800 was listening to a podcast at about the same time as the previous interaction between portable media player 804 and media delivery accessory 802 was terminated (e.g., the end user physically connected one from the other, one or both were powered down, and so forth), the MPMF can include information that can cause media system 800 to instantiate a current user experience of media system 800, the current user experience sharing at least one of the aspects of the most recent user experience. In this example, media system 800 can provide a next one in a series podcasts if the most recent podcast was completely processed, or continue where the last podcast left off. In one embodiment, contextual information (such a volume, treble, bass) can be used to further modify the processing of the media asset by media system 800. For example, portable media player 804 can modify audio processing by media delivery accessory 802 in accordance with information contained within the MPMF.

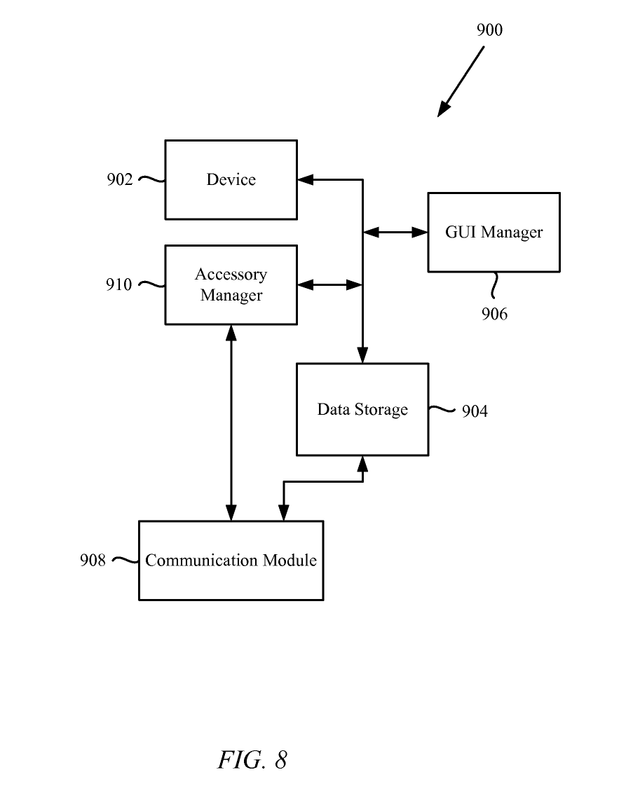

FIG. 8 is a block diagram of an arrangement 900 of functional modules utilized by a portable media device. The portable media device can, for example, be the media asset player 100 illustrated in FIG. 1. The arrangement 900 includes a media player 902 that is able to output media for a user of the portable media device but also store and retrieve data with respect to data storage 904. The arrangement 900 also includes a graphical user interface (GUI) manager 906. The GUI manager 906 operates to control information being provided to and displayed on a display device. The arrangement 900 also includes communication module 908 that facilitates communication between the portable media device and an accessory device. Still further, arrangement 900 includes an accessory manager 910 that operates to authenticate and acquire data from an accessory device that may be coupled to the portable media device. For example, the accessory device can be a wireless interface accessory, a wired interface accessory or any other suitable type interface accessory.

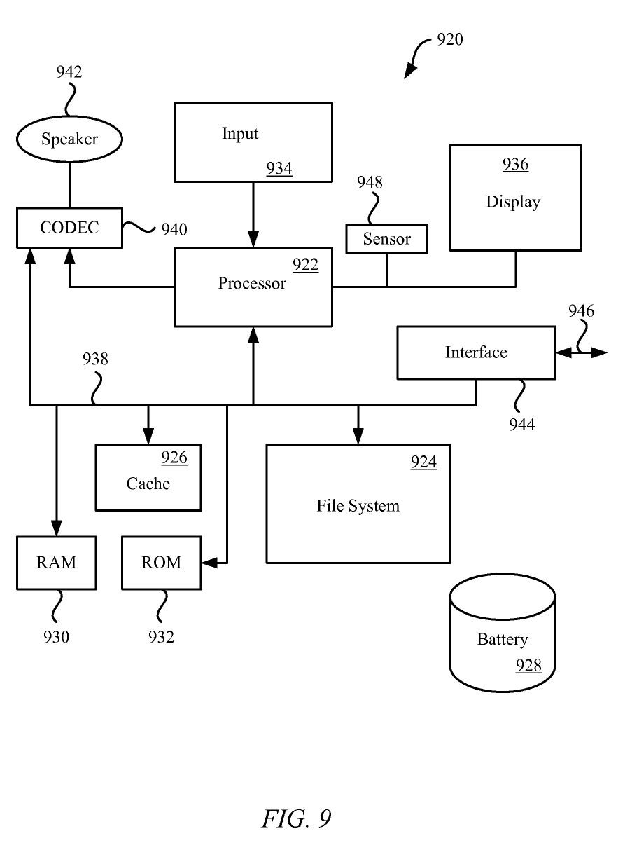

FIG. 9 is a block diagram of media player 920 in accordance with the described embodiments. The media player 920 illustrates circuitry of a representative portable media device. Media player 920 includes a processor 922 that pertains to a microprocessor or controller for controlling the overall operation of the media player 920. The media player 920 stores media data pertaining to media items in a file system 924 and a cache 926. The file system 924 is, typically, a storage disk or a plurality of disks. The file system 924 typically provides high capacity storage capability for the media player 920. However, since the access time to the file system 924 is relatively slow, the media player 920 can also include a cache 926. The cache 926 is, for example, Random-Access Memory (RAM) provided by semiconductor memory. The relative access time to the cache 926 is substantially shorter than for the file system 924. However, the cache 926 does not have the large storage capacity of the file system 924. Further, the file system 924, when active, consumes more power than does the cache 926. The power consumption is often a concern when the media player 920 is a portable media player that is powered by a battery 928. The media player 920 also includes a RAM 930 and a Read-Only Memory (ROM) 932. The ROM 932 can store programs, utilities or processes to be executed in a non-volatile manner. The RAM 930 provides volatile data storage, such as for the cache 926.

The media player 920 also includes a user input device 934 that allows a user of the media player 920 to interact with the media player 920. For example, the user input device 934 can take a variety of forms, such as a button, keypad, and dial, touch pad or screen. Still further, the media player 920 includes a display 936 (screen display) that can be controlled by the processor 922 to display information to the user. A data bus 938 can facilitate data transfer between at least the file system 924, the cache 926, the processor 922, and the CODEC 940.

In one embodiment, the media player 920 serves to store a plurality of media assets (e.g., songs, podcasts, etc.) in the file system 924. The media assets can pertain to one or more different types of media content. In one embodiment, the media assets are audio tracks (e.g., songs, audiobooks, and podcasts). In another embodiment, the media assets are images (e.g., photos) and/or video data. However, in other embodiments, the media assets can be any combination of audio, graphical or video content. When a user desires to have the media player play a particular media item, a list of available media items is displayed on the display 936. Then, using the user input device 934, a user can select one of the available media items. The processor 922, upon receiving a selection of a particular media item, supplies the media data (e.g., audio file) for the particular media item to a coder/decoder (CODEC) 940. The CODEC 940 then produces analog output signals for a speaker 942. The speaker 942 can be a speaker internal to the media player 920 or external to the media player 920. For example, headphones or earphones that connect to the media player 920 would be considered an external speaker. The media player 920 also includes a network/bus interface 944 that couples to a data link 946. The data link 946 allows the media player 920 to couple to a host computer or to accessory devices. The data link 946 can be provided over a wired connection or a wireless connection. In the case of a wireless connection, the network/bus interface 944 can include a wireless transceiver. Sensor 948 can be used to detect various external stimuli such as ambient light, temperature, pressure, and so on.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The many features and advantages of the presently described embodiments are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A method performed by a media asset player, comprising:
establishing communication between the media asset player and an external device, the media asset player including a memory device arranged to store a media asset and a processor arranged to process the media asset;
identifying the external device; and
processing the media asset by the media asset player in a manner in accordance with data stored on the media asset player at the termination of a previous communication between the identified external device and the media asset player only while the communication between the media asset player and the external device remains established,
wherein the data stored on the media asset player includes physical environment information related to a physical environment of the media asset player during the previous connection, and contextual environment information related to context of use of the media asset player during the previous communication.

2. The method as recited in claim 1, wherein the communication between the media asset player and the external device is wireless.

3. The method as recited in claim 1, wherein the external device is a docking station.

4. The method as recited in claim 3, further comprising:
determining if the docking station is associated with a media playback memento file retained in the media asset player; and
processing the media asset by the media asset player in accordance with the media playback memento file.

5. The method as recited in claim 4, further comprising:
receiving a docking station identifier by the media asset player from the docking station in response to the establishment of the communication channel;
comparing the received docking station identifier with docking station information stored in the memory device; and
associating the docking station to the media playback memento file only when the comparing indicates a match between the received docking station identifier and at least some of the retained docking station information.

6. The method as recited in claim 5, further comprising:
updating the media playback memento file with situational data related to the playing of the media assets only while the communication between the media asset player and the docking station remains established.

7. The method as recited in claim 6, further comprising:
identifying a cessation of the communication between the media asset player and the docking station by a de-docking signal;
pausing the playing of the media assets by the media asset player in response to the de-docking signal;
stopping the updating of the media playback memento file;
retaining a current version of the media playback memento file in the memory device; and
associating the current version of the media playback memento file with the docking station identifier.

8. The method as recited in claim 7, wherein when the communication between the media asset player and the external device is wireless, the de-docking signal corresponds to the media asset player and the external device moving out of range of each other.

9. A media playback system, comprising:
a first electronic circuit, comprising:
a processor,
a data store arranged to store at least a media asset, and
a first connector assembly; and
a second electronic circuit, comprising:
a second data store arranged to store at least a second electronic circuit identification information, and
a second connector assembly, wherein when the first and second connector assemblies are electrically coupled to each other, the first electronic circuit receives at least some of the second electronic circuit identification information and if it is determined by the first electronic circuit that the first electronic circuit and the second electronic circuit have been previously connected to each other, then the first electronic circuit processes the media asset in accordance with information stored in the data store that is related to a termination of the previous connection, and
further wherein the information stored is situational data comprising:
physical environment information related to a physical environment of the media playback system during the previous connection; and
contextual environment information related to context of use of the media playback system during the previous connection.

10. The media playback system as recited in claim 9, wherein the first electronic circuit is embodied as a portable media player and wherein the second electronic circuit is embodied as a media delivery accessory having the ability to play back the media asset stored in the data store of the media playback system.

11. (canceled)

12. The media playback system as recited in claim 10, wherein the second electronic information includes an identifier that uniquely identifies the second electronic circuit.

13. The media playback system as recited in claim 10, wherein the situational information is associated with a media playback memento file stored in the first data store.

14. The media playback system as recited in claim 13, wherein the portable media player uses the identifier received from the media delivery accessory to identify the media playback memento file associated with the most recent connection between the portable media player and the media delivery accessory.

15. The media playback system as recited in claim 14, wherein the processor uses the media playback memento file to process the media asset.

16. A non-transitory computer readable medium for storing a program executable by a processor in a media asset player, comprising:
computer code for establishing communication between the media asset player and a docking station, the media asset player including a memory device arranged to store at least a media asset and a processor arranged to process the media asset;
computer code for identifying the docking station; and
computer code for processing the media asset in a manner associated with a recorded state of the media asset player at the end of a previous communication between the identified docking station and the media asset player only while the communication between the media asset player and the docking station remains established,
wherein the recorded state includes information related to physical environmental conditions and context of use at the end of the previous communication.

17. The computer readable medium as recited in claim 16, further comprising:
computer code for determining if the docking station is associated with a media playback memento file stored in the media asset player; and
computer code for processing the media asset by the media asset player in accordance with the media playback memento file.

18. The computer readable medium as recited in claim 17, further comprising;
computer code for receiving a docking station identifier by the media asset player from the docking station in response to an initial establishment of the communication channel;
computer code for comparing the received docking station identifier with a docking station identifier stored in a memory device in the media asset player; and
computer code for associating the docking station to the media playback memento file only when the comparing indicates a match between the received docking station identifier and the stored docking station identifier.

19. The computer readable medium as recited in claim 18, further comprising:
computer code for updating the media playback memento file with situational data related to the playing of the media assets only while the communication between the media asset player and the docking station remains established.

20. The computer readable medium as recited in claim 17, further comprising;
computer code for pausing the playing of the media assets by the media asset player in response to a de-docking signal;
computer code for stopping the updating of the media playback memento file;
computer code for storing a current version of the media playback memento file in the memory device of the media asset player; and
computer code for associating the current version of the media playback memento file with the docking station identifier.

21. The computer readable medium as recited in claim 16, wherein the media asset player is a portable media player.

22. A media asset player, comprising:
a data store arranged to store at least a media asset;
a connector assembly arranged to facilitate an establishment of a communication channel between the media asset player and another electronic circuit; and
a processor,
wherein when the communication channel between the media asset player and the other electronic circuit is established, the processor
identifies the other electronic circuit,
retrieves the media asset from the data store,
processes the media asset in a manner associated with the identified other electronic circuit only while the communication channel between the media asset player and the other electronic circuit remains established, and
further wherein when the communication channel between the media asset player and the other electronic circuit is disestablished, the processor
records an end state of the media asset player to a location on the data store of the media asset player, the end state including information related to physical environmental conditions and context of use of the media asset player at the end of the previous communication.

23. The media asset player as recited in claim 22, wherein the other electronic circuit is coupled to a dock connector.

24. The media asset player as recited in claim 22, wherein the processor determines if the dock connector is associated with a media playback memento file retained in the data store of media asset player and processes the media asset in accordance with the media playback memento file.

25. The media asset player as recited in claim 22, wherein the processor associates the dock connector to the media playback memento file only when the processor determines that there is a match between the dock identifier and at least some of the data retained in the data store.

26. A method performed by a media asset player, the media asset player including a memory device arranged to store at least a media asset and a processor arranged to process the media asset, comprising:
relationally processing a media asset by the media asset player, the relational processing of the media asset in accordance with information recorded on the memory device about a termination of a previous communication between the media asset player and another electronic device,
wherein the information recorded is situational data, comprising:
physical environment information related to a physical environment of the media asset player during the previous connection; and
contextual environment information related to context of use of the media asset player during the previous connection.

27. The method as recited in claim 26, wherein the other electronic device is coupled with a docking station, the method further comprising:
establishing communication between the media asset player and the docking station;
determining if the media asset player and the docking station have the previous relationship by the processor identifying the docking station;
accessing situational data corresponding to the previous relationship; and
relationally processing the media asset in accordance with the situational data only while the communication between the media asset player and the docking station remains established.
